(19) United States
(12) Patent Application Publication
(10) Pub. No.: US 2019/0103627 A1
(43) Pub. Date: Apr. 4, 2019

(54) SOLID ELECTROLYTE COMPOSITIONS

(71) Applicant: Wildcat Discovery Technologies, Inc., San Diego, CA (US)

(72) Inventors: Alex Freigang, San Diego, CA (US); Bin Li, San Diego, CA (US); Cory O'Neill, San Diego, CA (US); Kyler Carroll, Cardiff, CA (US)

(21) Appl. No.: 15/725,176

(22) Filed: Oct. 4, 2017

(51) Int. Cl. H01M 10/056; H01M 10/0525; C08F 122/10

(52) U.S. Cl. CPC H01M 10/056; H01M 10/0525; H01M 2300/0091; H01M 2300/0082; H01M 2300/0071; C08F 122/105

(57) ABSTRACT

A formulation comprising a multifunctional acrylate monomer; a polymerization initiator; a plasticizer; an inorganic ion-conducting material; and a lithium salt. The formulation is polymerized to form a solid polymer electrolyte comprising a crosslinked acrylate homopolymer; a plasticizer; an inorganic ion-conducting material; and a lithium salt.

### BACKGROUND OF THE INVENTION

The present invention is in the field of battery technology and, more particularly, in the area of solid materials and composite materials for use in electrolytes in electrochemical cells.

Conventional lithium ion batteries include a positive electrode (or cathode as used herein), a negative electrode (or anode as used herein), an electrolyte, and, frequently, a separator. The electrolyte typically includes a liquid component that facilitates lithium ion transport and, in particular, enables ion penetration into the electrode materials.

In contrast, so-called solid-state lithium ion batteries do not include liquid in their principal battery components. Solid-state batteries can have certain advantages over liquid electrolyte batteries, such as improvements in safety because liquid electrolytes often contain volatile, flammable organic solvents. Solid-state batteries offer a wider range of packaging configurations because a liquid-tight seal is not necessary as it is with liquid electrolytes.

Generally, batteries having a solid-state electrolyte can have various advantages over batteries that contain liquid electrolyte. For small cells, such as those used in medical devices, the primary advantage is overall volumetric energy density. For example, small electrochemical cells often use specific packaging to contain the liquid electrolyte. For a typical packaging thickness of 0.5 mm, only about 60% of the volume can be used for the battery with the remainder being the volume of the packaging. As the cell dimensions get smaller, the problem becomes worse.

Elimination of the liquid electrolyte facilitates alternative, smaller packaging solutions for the battery. Thus, a substantial increase in the interior/exterior volume can be achieved, resulting in a larger total amount of stored energy in the same amount of space. Therefore, an all solid-state battery is desirable for medical applications requiring small batteries. The value is even greater for implantable, primary battery applications as the total energy stored often defines the device lifetime in the body.

Beyond medical applications, solid-state batteries can use lithium metal as the anode, thereby dramatically increasing the energy density of the battery as compared to the carbon-based anodes typically used in liquid electrolyte lithium ion batteries. The specific capacity of lithium exceeds that of carbon substantially. Thus, rechargeable batteries for use in consumer electronics, automotive, and other applications benefit from the higher energy density anode. With repeated cycling, lithium metal can form dendrites, which can penetrate a conventional porous separator and result in electrical shorting and runaway thermal reactions. This risk is mitigated through the use of a solid electrolyte for preventing penetration of lithium dendrites and enabling the safe use of lithium metal anodes, which directly translates to large gains in energy density, irrespective of cathode chemistry.

However, solid-state batteries have not achieved widespread adoption because of practical limitations. For example, while polymeric solid-state electrolyte materials like poly(ethylene oxide) (“PEO”) are capable of conducting lithium ions, their ionic conductivities are inadequate for practical power performance. Successful solid-state batteries require thin film structures, which reduce energy density. But, a battery with reduced energy density has limited utility.

Further, solid-state batteries tend to have a substantial amount or degrees of interfaces among the different solid components of the battery. The presence of such interfaces can limit lithium ion transport and impede battery performance. Interfaces can occur (i) between the domains of active material in the electrode and other components in the electrode, (ii) between the cathode and the solid electrolyte, (iii) between domains of varying composition within the solid electrolyte, and (iv) between the solid electrolyte and the anode structure. Poor lithium ion transport across these interfaces results in high impedance in batteries and a low capacity on charge or discharge.

A polymer solid-state electrolyte is commonly understood to have the following advantages: (i) relatively easily processed by standard solution casting or slurry casting techniques; (ii) mechanical flexibility allowing the polymer to conform to electrode surfaces, allowing for good mechanical compliance and comparatively low loss of surface contact during cycling; and (iii) relatively easy to drop in to existing lithium ion battery manufacturing with solid polymer films similar to today's separators.

However, a polymer solid-state electrolyte is also commonly understood to have the following disadvantages: (i) relatively low conductivity, on the order of 10⁻⁶-10⁻⁵ S/cm at room temperature; (ii) current state of the art polymer solid-state electrolytes typically consist of PEO-type polymers, which have poor stability at high voltage (for example, greater than about 4.2 V); and (iii) common polymer solid-state electrolytes actually form relatively soft films that are not expected to prevent lithium dendrite penetration.

Certain solid polymer electrolytes have been investigated in the past. For example, U.S. Pat. No. 5,219,679 discloses a blend of polymers for fabricating a solid polymer electrolyte. In this reference, the film is fabricated starting with polymers that are further cross-linked. In another example, U.S. Pat. No. 6,368,746 discloses amorphous solid polymer electrolyte films. These films were fabricated from a non-acrylate polymer and include ion-conductive sulfide glass. In still another example, U.S. Published Application 2005/0196678 discloses multiple monomers for use in polymerizing a solid polymer electrolyte film. In still another example, U.S. Published Application 2011/0256456 discloses in situ polymerization to create a gel polymer electrolyte, as opposed to a solid polymer electrolyte. Finally, U.S. Pat. No. 6,368,746 discloses a polymerized solid polymer film. None of these electrolyte formulations addresses the limitations discussed herein and none provide the thermal stability improvements seen in the embodiments disclosed below.

### BRIEF SUMMARY OF THE INVENTION

Embodiments of the present invention include a formulation comprising a multifunctional acrylate monomer; a polymerization initiator; a plasticizer; an inorganic ion-conducting material; and a lithium salt. In some embodiments, the multifunctional acrylate monomer is represented by formula (e):

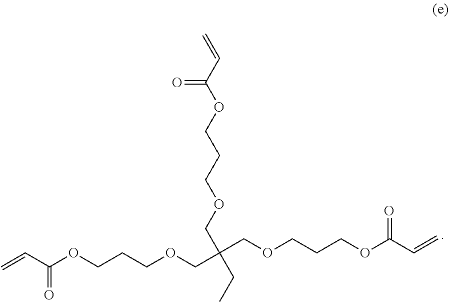 [SMILES: C=CC(=O)OCCCOCC(CC)(COCCCOC(=O)C=C)COCCCOC(=O)C=C]

In some embodiments, the polymerization initiator comprises a free-radical initiator activated by photo initiation, thermal initiation, or electron beam initiation. In some embodiments, the polymerization initiator comprises 2-hydroxy-2-methylpropiophenone. In some embodiments, the plasticizer comprises an organic molecule with high dielectric constant. In some embodiments, the plasticizer comprises ethylene carbonate. In some embodiments, the plasticizer comprises a nitrile-based organic crystal. In some embodiments, the plasticizer comprises succinonitrile. In some embodiments, the inorganic ion-conducting material is selected from the group consisting of Al₂O₃, SiO₂, TiO₂, and ZrO₂. In some embodiments, the inorganic ion-conducting material comprises a garnet-type ion conducting material or a NASICON-type ion conducting material. In some embodiments, the lithium salt comprises lithium bis(trifluoromethanesulfonyl)imide.

Certain embodiments of the invention include a solid polymer electrolyte comprising a crosslinked acrylate homopolymer; a plasticizer; an inorganic ion-conducting material; and a lithium salt. In some embodiments, the polymerization initiator comprises a free-radical initiator activated by photo initiation, thermal initiation, or electron beam initiation. In some embodiments, the polymerization initiator comprises 2-hydroxy-2-methylpropiophenone. In some embodiments, the plasticizer comprises an organic molecule with high dielectric constant. In some embodiments, the plasticizer comprises ethylene carbonate. In some embodiments, the plasticizer comprises a nitrile-based organic crystal. In some embodiments, the plasticizer comprises succinonitrile. In some embodiments, the inorganic ion-conducting material is selected from the group consisting of Al₂O₃, SiO₂, TiO₂, and ZrO₂. In some embodiments, the inorganic ion-conducting material comprises a garnet-type ion conducting material or a NASICON-type ion conducting material. In some embodiments, the lithium salt comprises lithium bis(trifluoromethanesulfonyl)imide.

Embodiments of the present invention include a lithium ion battery having an anode, a cathode comprising an electrode active material, and a solid-state electrolyte.

Embodiments of the invention include methods of making a solid-state electrolyte and a battery containing a solid-state electrolyte, as well as methods of conditioning and using such a battery.

### BRIEF DESCRIPTION OF SEVERAL VIEWS OF THE DRAWINGS

FIG. 1 illustrates the results of electrochemical impedance spectroscopy measurement of the temperature dependence of solid-state electrolyte formulations according to certain embodiments of the invention.

FIG. 2 illustrates the results of electrochemical impedance spectroscopy measurement of the temperature dependence of solid-state electrolyte formulations according to certain embodiments of the invention.

FIG. 3 illustrates the results of electrochemical impedance spectroscopy measurement of the time dependence of solid-state electrolyte formulations according to certain embodiments of the invention.

FIGS. 4A and 4B illustrate characterization of the transference number of a liquid electrolyte according to certain embodiments of the invention.

FIGS. 5A and 5B illustrate characterization of the transference number of a solid-state electrolyte according to certain embodiments of the invention.

FIG. 6 illustrates stable plating and stripping of lithium as a function of time in cells containing solid-state electrolyte formulations according to certain embodiments of the invention.

FIG. 7 illustrates electrochemical characterization at room temperature of battery cells including solid-state electrolyte formulations according to certain embodiments of the invention.

FIG. 8 illustrates electrochemical characterization at elevate temperature of battery cells including solid-state electrolyte formulations according to certain embodiments of the invention.

FIG. 9 illustrates capacity retention as a function of C-rate for battery cells including solid-state electrolyte formulations according to certain embodiments of the invention.

FIG. 10 illustrates the results of electrochemical impedance spectroscopy measurement of the plasticizer dependence of solid-state electrolyte formulations according to certain embodiments of the invention.

FIG. 11 illustrates the results of electrochemical impedance spectroscopy measurement of the plasticizer, temperature, and time dependence of solid-state electrolyte formulations according to certain embodiments of the invention.

FIG. 12 illustrates unstable plating and stripping of lithium in cells containing solid-state electrolyte formulations according to certain embodiments of the invention.

FIG. 13 illustrates x-ray diffraction characterization of solid-state electrolyte formulations according to certain embodiments of the invention.

FIG. 14 illustrates the results of electrochemical impedance spectroscopy measurement of the plasticizer dependence of solid-state electrolyte formulations according to certain embodiments of the invention.

FIG. 15 illustrates unstable plating and stripping of lithium in cells containing solid-state electrolyte formulations according to certain embodiments of the invention.

FIG. 16 illustrates unstable plating and stripping of lithium in cells containing solid-state electrolyte formulations with different amounts of salt according to certain embodiments of the invention.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely, as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein.

A “C-rate” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

The term “NMC” refers generally to cathode materials containing LiNiₓMn_{y}Co_{z}O₂, where x+y+z≤1. NMC includes, but is not limited to, cathode materials containing LiNi_{0.33}Mn_{0.33}Co_{0.33}O₂, LiNi_{0.5}Mn_{0.3}Co_{0.2}O₂. (sometimes referred to as NMC (532)), and LiNi_{0.6}Mn_{0.2}Co_{0.2}O₂ (sometimes referred to as NMC (622)).

The term “solid-state electrolyte” as used herein is used primarily to distinguish from electrolyte formulations where the formulation is an entirely liquid phase, almost entirely liquid phase, or substantially liquid phase.

The term “polymer” as used herein refers generally to a molecule whose structure is composed of multiple repeating units. The structure can be linear or branched. The term includes co-polymers of all types. As with other applications using polymeric materials, the properties of the solid structure of the polymeric material can be influenced by (i) the choice of polymer, (ii) the molecular weight of the polymer, (iii) the polydispersity of the polymer, (iv) the processing conditions, and (v) the presence of additives. While combinations of these factors are generally known, it is not necessarily predictable how these various factors will interact in a given application. Certain polymeric materials have shown utility for use in solid-state electrolyte formulations based on the combination of factors listed above.

The term “monomer” as used herein refers generally to a molecule of low molecular weight capable of reacting with identical or different molecules of low molecular weight to form a polymer.

The term “alkyl group” as used herein refers to a monovalent form of an alkane. For example, an alkyl group can be envisioned as an alkane with one of its hydrogen atoms removed to allow bonding to another group. Alkyls include lower alkyls (an alkyl that includes from 2 to 20 carbon atoms, such as from 2 to 10 carbon atoms), upper alkyls (an alkyl that includes more than 20 carbon atoms, such as from 21 to 100 carbon atoms), cycloalkyls (an alkyl that includes one or more ring structures), heteroalkyls (an alkyl that has one or more of its carbon atoms replaced by one or more heteroatoms, such as N, Si, S, O, F, and P), and branched forms of all such alkyls. Alkyls can be substituted such that one or more of its hydrogen atoms is replaced by one or more substituent groups, such as halo groups. An alkyl can have a combination of characteristics. For example, a substituted lower alkyl can refer to an alkyl. Examples of alkyl groups include methyl, ethyl, n-propyl, isopropyl, cyclopropyl, butyl, isobutyl, t-butyl, cyclobutyl, and hetero, or substituted forms thereof.

The term “alkoxy group” as used herein refers to the group O-alkyl, wherein “alkyl” is defined as above. Alkoxy groups can be substituted such that one or more of its hydrogen atoms is replaced by one or more substituent groups, such as halo groups.

Ranges presented herein are presumed to be inclusive of their endpoints unless context dictates otherwise. Thus, for example, the range 1 to 3 includes the values 1 and 3, as well as intermediate values.

Certain embodiments of the invention relate to formulations for solid-state electrolytes, the solid-state electrolytes formed from such formulations, the methods of preparing the solid-state electrolyte formulations, the methods of preparing the solid-state electrolytes, and electrochemical cells including the solid-state electrolytes.

Embodiments of the solid-state electrolyte formulations include a monomer polymerized using free-radical polymerization, a polymerization initiator, an organic crystal providing high ionic conductivity, a plasticizer, a lithium salt, and an inorganic compound. The combination of these materials as disclosed herein yields a flexible and standalone solid-state electrolyte film that demonstrates thermal stability and desirable electrochemical performance. Certain embodiments of the solid-state electrolyte film can enable near theoretical capacity in solid-state electrochemical cells and in particular electrochemical cells having an NMC cathode and lithium metal anode.

Solid-state electrolyte formulations disclosed herein include a molecule having an acrylate group that is polymerizable using free-radical polymerization. Many molecules can undergo free-radical polymerization, but of particular interest for certain embodiments of the invention are acrylates. A generic structure of an acrylate group can be represented by formula (a):

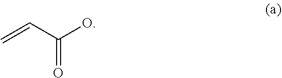

Preferred molecules for the embodiments disclosed herein contain multiple acrylate groups and are capable of polymerizing into a crosslinked polymer network. That is, the preferred acrylate molecules are multifunctional. The most preferred molecules therefore contain at least three acrylate groups (that is, they are tri-functional acrylates). A tri-functional structure can be represented by formula (b):

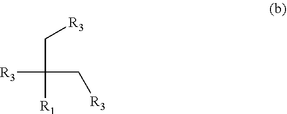

where R₁ is selected from alkyl groups and alkoxy groups. R₃ is selected from moieties that include both alkoxy groups and acrylate groups. For example, certain preferable R₃ moieties can be represented by formula (c) or formula (d):

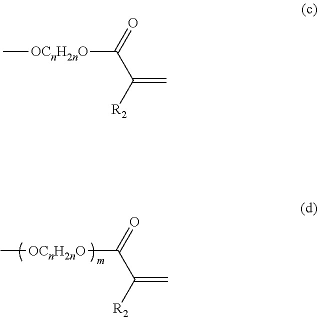

where R₂ is selected from alkyl groups and n and m are each independently selected to be a positive integer. In certain preferred embodiments, n is an integer less than or equal to 6. In certain particularly preferred embodiments, n is 2 or 3. In certain preferred embodiments, 5≤m≤2000. The acrylate groups in the R₃ molecules are capable of forming a free-radical for polymerization and the ether groups aid lithium ion conductivity. Generally, the preferred R₃ molecules are liquids at room temperature, but other R₃ molecules are suitable for use as monomers for free-radical polymerization.

In certain preferred embodiments, the acrylate monomer is trimethylolpropane propoxylate triacrylate, which is represented by formula (e):

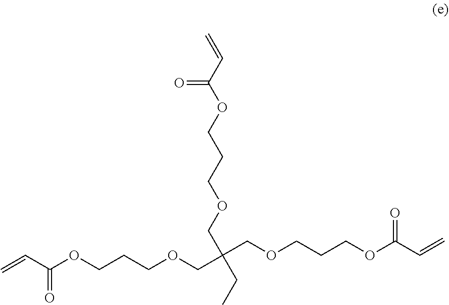 [SMILES: C=CC(=O)OCCCOCC(CC)(COCCCOC(=O)C=C)COCCCOC(=O)C=C]

Preferred monomers include acrylate monomers such as trimethylolpropane propoxylate triacrylate and routine chemical modifications of these monomers provided that the modifications do not substantially diminish the desired properties of the polymers and solid-state electrolytes formed therefrom. In preferred embodiments, the monomer is polymerized to form a homopolymer.

In the most preferred embodiments, the monomer is polymerized to form a cross-linked polymer component that provides a mechanical framework for the solid-state electrolyte. The polymer also includes transitory binding sites for lithium mobility through the solid-state electrolyte film. Thus, the preferred polymer component provides structural and electrochemical properties suited to performance as a solid-state electrolyte film.

Solid-state electrolyte formulations disclosed herein include an initiator molecule to facilitate the free-radical polymerization. Generally, initiation methods compatible with in situ polymerization can be used. Examples of such initiation methods include photo initiation, thermal initiation, and electron beam initiation, although other means of initiating free-radical polymerization are within the scope of this disclosure. While any form of free-radical initiation may be suitable for the embodiments disclosed herein, photo-initiation is a preferred form for certain embodiments. In other preferred embodiments, thermal initiation may be preferred for ease of manufacture.

In embodiment of photo initiation, using ultra-violet (UV) light is particularly preferred. Such initiators include, but are not limited to: acetophenone, anisoin, anthraquinone, anthraquinone-2-sulfonic acid, (benzene) tricarbonylchromium, benzil, benzoin, benzophenone, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, camphorquinone, 2-chlorothioxanthen-9-one, (cumene)cyclopentadienyliron(II) hexafluorophosphate, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, 4′-ethoxyacetophenone, 2-ethylanthraquinone, ferrocene, hydroxyacetophenone, 1-hydroxycyclohexyl phenyl ketone, 2-hydroxy-2-methylpropiophenone, 2-methylbenzophenone, methybenzoylformate, 2-methyl-4′-(methylthio)-2-morpholinopropio-phenone, [symbol] phenanthrenequinone, 4′-phenoxyacetophenone, thioxanthen-9-one, triarylsulfonium hexafluoroantimonate salts, and combinations thereof. Of course, to the extent the initiators listed above can be activated by means other than light, those initiation methods are included.

One particularly preferred photo-initiator is 2-hydroxy-2-methylpropiophenone, which is represented by formula (f):

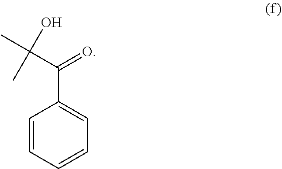

The combination of the monomer and initiator creates the cross-linked polymer network with the structural and electrochemical properties described above. The solid-state electrolyte must also include a lithium salt. The lithium salts used to create the improved solid-state electrolytes disclosed herein include, but are not limited to, lithium bis(trifluoromethanesulfonyl)imide (CF₃SO₂NLiSO₂CF₃) (also referred to herein as “LiTFSI”), lithium tetrafluoroborate (LiBF₄), lithium hexafluoroarsenate (LiAsF₆), lithium bis(oxalato)borate (LiB(C₂O₄)₂) (also referred to herein as “LiBOB”), lithium perchlorate (LiClO₄), lithium hexafluorophosphate (LiPF₆), lithium bis(fluorosulfonyl)imide (LiFSI), and lithium triflate (LiCF₃SO₃). Preferably, lithium bis(trifluoromethanesulfonyl)imide is used in the solid-state electrolyte formulations.

The properties and performance of the solid-state electrolyte films disclosed herein are further improved by the addition of plasticizing components that provide both mechanical and electrochemical features. At the most general level, anything that disrupts crystallinity in the polymer would be considered a plasticizer. Such plasticizers can be used to reduce physical and chemical interactions between segment of polymer chains, decreasing the glass transition temperature, melt viscosity and elastic modulus of the polymer being plasticized. These plasticizers are typically non-volatile materials with good compatibility with the target polymers.

The solid-state electrolyte films benefit from the inclusion of plasticizing compounds that can increase polymer chain mobility and reduce crystallinity within the film. One benefit of increased polymer chain mobility and reduced crystallinity is that the mechanical and electrochemical properties of the solid-state electrolyte can be distributed isotropically throughout the electrolyte film.

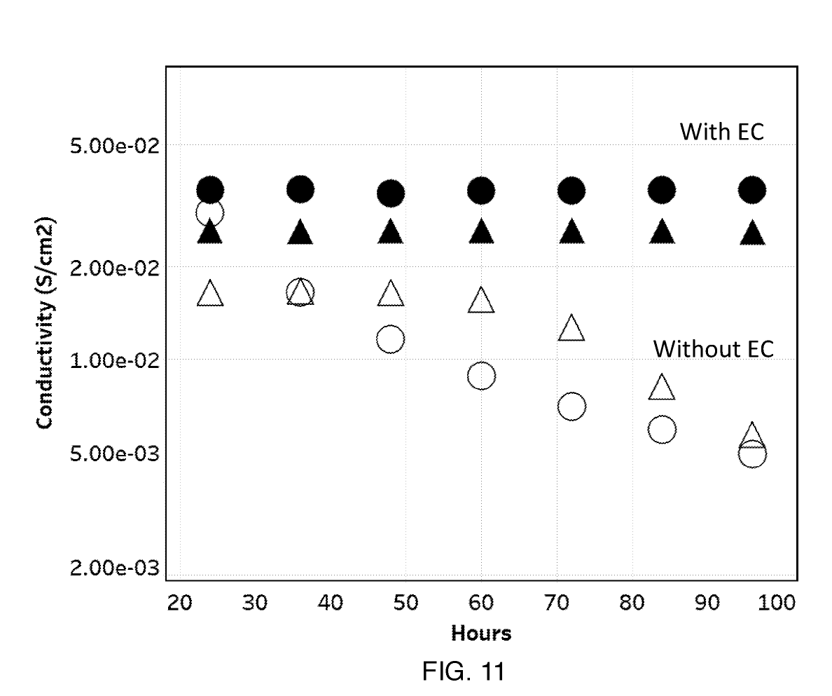

The preferred plasticizing components can include organic molecules that are typically liquid at room temperature or those that have melting points near room temperature. Plasticizers with this temperature profile are suitable to increase polymer chain mobility and reduce crystallinity in the cross-linked polymer films disclosed herein. Organic molecules with high dielectric constants are particularly preferred. Such molecules include, but are not limited to, ethylene carbonate (EC), fluoroethylene carbonate (FEC), propylene carbonate (PC), dimethyl formamide (DMF), diethyl carbonate (DEC), and dimethyl carbonate (DMC). EC in this case also significantly improve the thermal stability of the solid state electrolyte as shown in FIG. 11.

In certain embodiments, nitrile-based organic crystals are particularly preferred for use with the polymers formed from the acrylate monomers disclosed herein. Through experimentation, it has been found that nitrile-based organic crystals improve the physical property of certain acrylate polymers. In general, it is desirable to have multiple nitrile functional groups within each plasticizer molecule.

The preferred examples of nitrile-based plasticizers that work particularly well with polyacrylates include, but are not limited to, the following: fumaronitrile; tetracyanoethylene, 1,2,4,5-tetracyanobenzene, 7,7,8,8-etercyanoquinodimethane, succinonitrile, glutaronitrile, adiponitrile, suberonitrile, 1,2-dicyanocyclohexane, 1,2,-dicyanobenzene, hexane-1,3,6-tricarbonitrile and ethylene glycol bis(propionitrile) ether.

One particularly preferred nitrile-based organic crystal is succinonitrile, which is represented by formula (g):

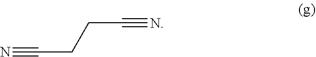

Succinonitrile is particularly preferred because it serves not only as a plasticizer to the polymer network, but also can dissociate (or ionize) the lithium salt. By dissociating the lithium salt, succinonitrile facilitates the production of lithium ions and results in a greater number of migrating ions available for charge transport.

Both the crystalline and liquid plasticizer components provide improvements in the electrochemical properties of the solid-state electrolyte films by solvating lithium cations, which provides additional and separate ion conduction pathways. In some cases, the plasticizers, and in particular the liquid plasticizers, can also significantly improve the thermal stability of the solid state electrolyte. These improvements in thermal stability are a novel and unexpected aspect of the formulations disclosed herein.

Finally, yet another type of component can improve the mechanical and electrochemical properties of solid-state electrolyte films. Inorganic, ion-conductive materials can provide mechanical strength and lithium ion conduction. The preferred inorganic, ion-conductive materials are in the form of particles, include microparticles and nanoparticles. The length scale and chemical composition of such particles can decrease undesirable crystallinity in the polymer network, increase polymer chain mobility, increase ion conductivity, increase cation transference, improve mechanical and thermal stability, and improve polymer dielectric properties.

Suitable inorganic, ion-conductive materials include conductive oxides such as Al₂O₃, SiO₂, TiO₂, and ZrO₂. Other suitable inorganic, ion-conductive materials include garnet-type lithium ion conductors, including but not limited to, ion-conductive materials related to Li₅La₃Ta₂O₁₂ or Li₇La₃Zr₂O₁₂. Still other inorganic, ion-conductive materials include NASICON-type lithium ion conductors (NASICON is an acronym for sodium super ionic conductor), including but not limited to, ion-conductive materials related to Li_{1.3}Ti_{1.7}Al_{0.3}(PO₄)₃ or Li_{1.5}Al_{0.5}Ge_{1.5}(PO₄)₃. One particularly preferred inorganic material is alumina (or aluminum oxide, such as, but not limited to, Al₂O₃). Alumina microparticles or nanoparticles are particularly preferred.

According to certain embodiments of the invention, the components of the electrolyte formulations can be combined in various weight percent ratios, where the weight percent refers to the percent of a component as compared to the total weight of the formulation. For example, the monomer can be present in the solid-state electrolyte formulation at a weight percent of from about 2% to about 30%, the initiator can be present in the solid-state electrolyte formulation at a weight percent of from about 0.01% to about 1%, the lithium salt can be present in the solid-state electrolyte formulation at a weight percent of from about 5% to about 30%, the liquid plasticizer can be present in the solid-state electrolyte formulation at a weight percent of from about 5% to about 65%, the organic crystalline plasticizer can be present in the solid-state electrolyte formulation at a weight percent of from about 5% to about 65%, and the inorganic, ion-conductive material can be present in the solid-state electrolyte formulation at a weight percent of from about 5% to about 50%.

The solid-state batteries formed using the solid electrolyte formulations disclosed herein can be used with electrode configurations and materials known for use in solid-state batteries. The active material for use in the cathode can be any active material or materials useful in a lithium ion battery cathode, including the active materials in lithium metal oxides or layered oxides (e.g., Li(NiMnCo)O₂), lithium-rich layered oxide compounds, lithium metal oxide spinel materials (e.g., LiMn₂O₄, LiNi_{0.5}Mn_{1.5}O₄), olivines (e.g., LiFePO₄, etc.). Preferred cathode active materials include lithium cobalt oxide (e.g., LiCoO₂) and lithium layered oxides (e.g., Li(Mn,Ni,Co)O₂. Active materials can also include compounds such as silver vanadium oxide (SVO), metal fluorides (e.g., CuF₂, FeF₃), and carbon fluoride (CFₓ). The finished cathode can include a binder material, such as poly(tetrafluoroethylene) (PTFE) or poly(vinylidene fluoride) (PVdF). More generally, the active materials for cathodes can include phosphates, fluorophosphates, fluorosulfates, silicates, spinels, and composite layered oxides. The materials for use in the anode can be any material or materials useful in a lithium ion battery anode, including lithium-based, silicon-based, titanium based oxides and carbon-based anodes.

As demonstrated by the examples and experimental data disclosed herein, a novel and unexpected feature of certain embodiments of these formulations is their temperature stability. Several sets of the experimental data disclosed herein demonstrate excellent electrochemical stability at elevated temperature. Conventional polymer electrolytes can be sensitive to elevated temperature and can show unstable electrochemical behavior when cycled at elevated temperature.

The following examples of methods and results describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Methods

Unless otherwise specified, all materials were used as received and all experiments were carried out in an argon atmosphere glovebox (MBraun, O₂ and H₂O<0.1 ppm).

Preparation of Electrolyte Films.

Exemplary components and amounts to fabricate solid-state electrolyte films are identified in Table 1. Variations in the amounts of each component are within the scope of this disclosure. In an example of a specific embodiment, succinonitrile, ethylene carbonate, and LiTFSI are mixed and stirred together at 70 degrees Celsius for 1 hour. Vacuum dried 200 nm particles of Al₂O₃, trimethylolpropane propoxylate triacrylate, and 2-hydroxy-2-methyl-1-phenyl-1-propanone are added to that mixture and further stirred at 70 degrees Celsius for 1 hour. After mixing, the electrolyte slurry is coated via a doctor blade onto a Teflon surface. The film is then irradiated using a 55W mercury lamp for 2 minutes. The solid-state electrolyte film can be cut to desired geometries. The typical solid-state electrolyte film dry thickness was between about 20 microns and about 300 microns.

TABLE 1
Exemplary components to make solid state electrolyte

| | Example | Range |
|---|---|---|
| Component | Weight % | Weight % |
| Succinonitrile | 23.31 | 5-65 |
| Ethylene Carbonate | 31.23 | 5-65 |
| LiTFSI | 13.59 | 5-30 |
| Al₂O₃ nanoparticles | 21.25 | 5-50 |
| Trimethylolpropane propoxylate triacrylate | 10.62 | 5-30 |
| 2-hydroxy-2-methyl-1-phenyl-1-propanone | <0.1 | 0.01-1 |

Symmetric Lithium Cell Assembly.

A stack formed of a lithium electrode, the solid-state electrolyte, and another lithium electrode is assembled without heat or pressure treatment. Cells were sealed and tested with frequency range 1 Hz to 1 MHz. The plating and stripping protocol is shown in Table 2.

TABLE 2
Plating/Stripping Protocol

| # of cycles | mA/cm² | mAh/cm² |
|---|---|---|
| 1 | 0.05 | 0.01 |
| 1 | 0.10 | 0.01 |
| 1 | 0.16 | 0.02 |
| 1 | 0.21 | 0.02 |
| 1 | 0.26 | 0.03 |
| 1 | 0.31 | 0.03 |
| 1 | 0.37 | 0.04 |
| 1 | 0.42 | 0.04 |
| 1 | 0.47 | 0.05 |
| 1 | 0.56 | 0.06 |
| 5 | 1.05 | 1.05 |
| 5 | 2.09 | 2.09 |
| 5 | 3.14 | 3.14 |
| 5 | 4.19 | 4.19 |
| 100 | 5.23 | 5.23 |
| 1000 | 10.46 | 10.46 |

Battery Cell Assembly.

All solid-state cells include NMC622 cathode (LiNi_{0.6}Co_{0.2}Mn_{0.2}), a solid-state electrolyte of the embodiments disclosed herein, and a lithium metal anode. A stack formed of the cathode, the solid-state electrolyte, and lithium anode is assembled and heat-treated at 100 degrees Celsius for 1 hour under mild pressure (about 0.18 kg/cm²). The cells were sealed and cycled. All cells were cycled at 45 degrees Celsius or 30 degrees Celsius between 3.0 V and 4.1V with formation rate C/50 or C/10 then tested at cycling rates varying between C/50 and C/3.

Cell Characterization.

Electrochemical impedance spectroscopy (EIS) is used to determine the ionic conductivity of the solid-state electrolyte films. A film with known thickness and area is placed between two lithium substrates as described in Symmetric Lithium Cell Assembly above. An alternating current voltage (10 mV) is applied at varying frequencies. The resulting amplitude change and phase shift in the response is used to calculate ionic conductivity of the film. The electrochemical impedance figures illustrate the conductivity tested at a frequency of 44,668 Hz.

### Results

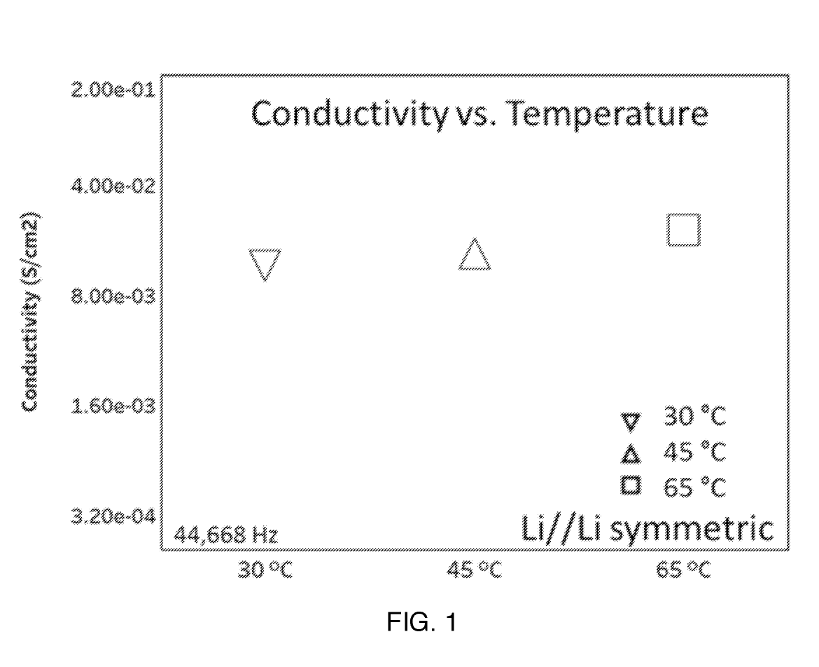

FIG. 1 illustrates the results of electrochemical impedance spectroscopy measurement of the temperature dependence of solid-state electrolyte formulations according to certain embodiments of the invention. The combination of these components yield a slurry that can be coated and cured into a thin film form factor which demonstrates very high ionic conductivity that increases with temperature. The films tested in FIG. 1 were fabricated according to the examples disclosed herein. These films are stable at elevated temperatures such as 45 degrees Celsius and 65 degrees Celsius.

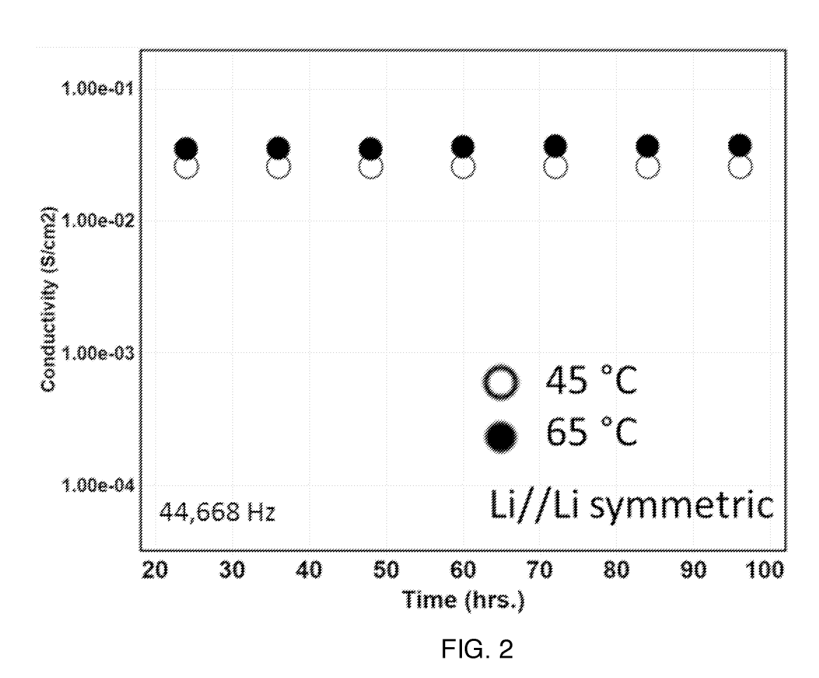

FIG. 2 illustrates the results of electrochemical impedance spectroscopy measurement of the temperature dependence of solid-state electrolyte formulations according to certain embodiments of the invention. These measurements using symmetric lithium cells show stable conductivity over time at both 45 degrees Celsius and 65 degrees Celsius. Unexpectedly, films fabricated according to the examples disclosed herein are thermally stable over a significant time period at these elevated temperatures.

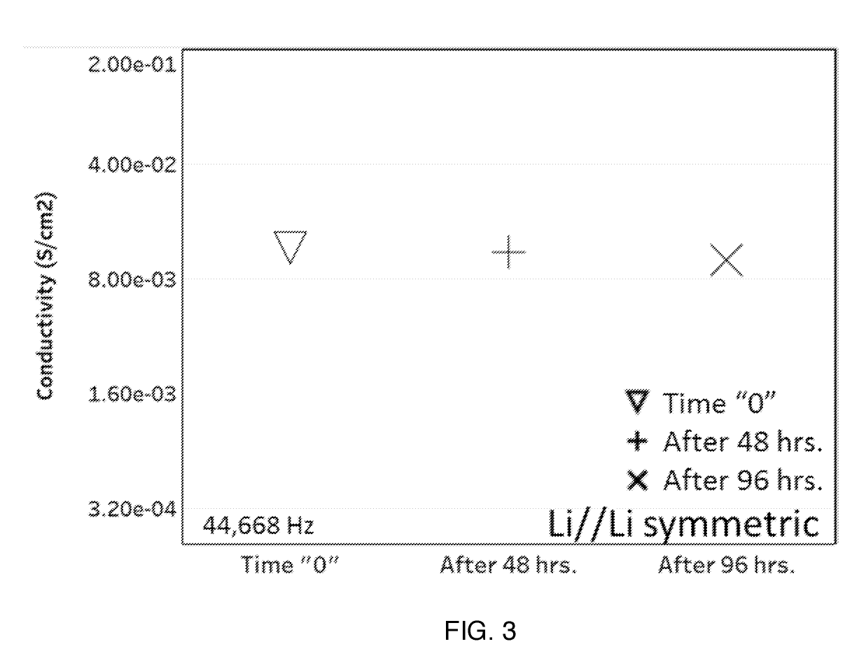

FIG. 3 illustrates the results of electrochemical impedance spectroscopy measurement of the time dependence of solid-state electrolyte formulations according to certain embodiments of the invention. These measurements using symmetric lithium cells show stable conductivity after storage at 120 degrees Celsius for the times indicated on the x-axis of FIG. 3. The conductivity measurements were taken at room temperature. Thus, films fabricated according to the examples disclosed herein are thermally stable at significantly elevated temperatures.

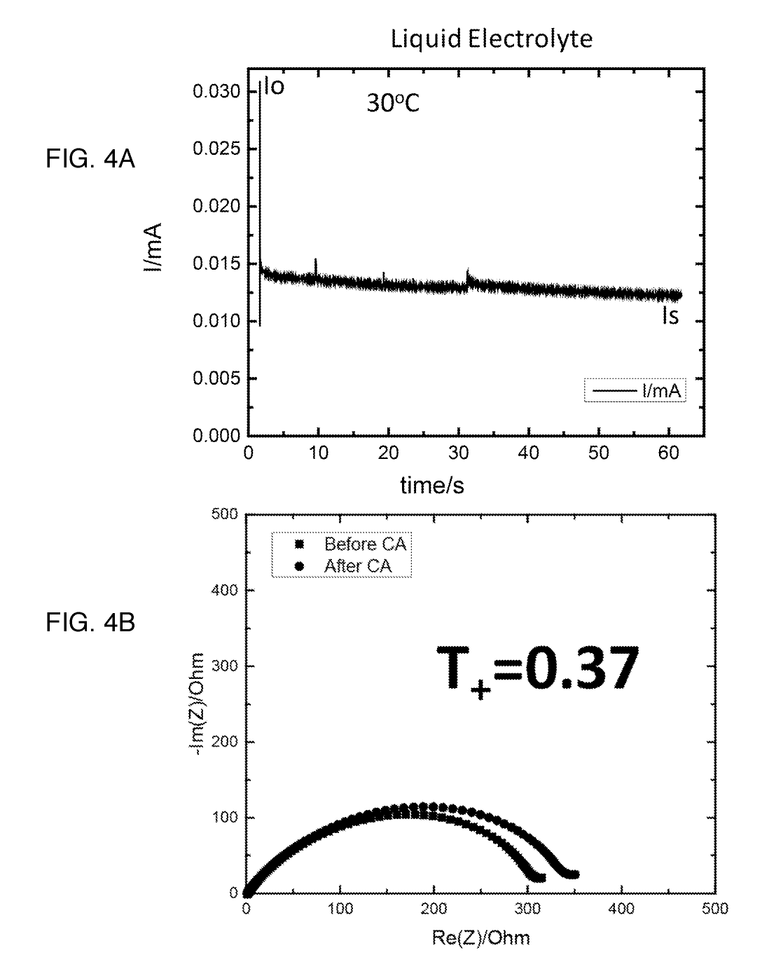

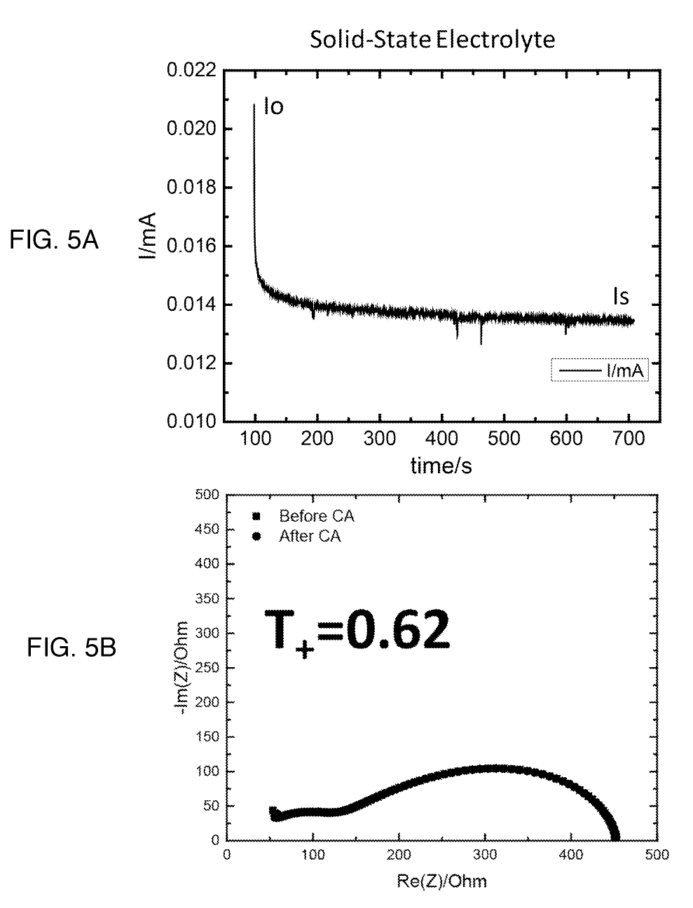

FIGS. 4A and 4B illustrate characterization of the transference number of a liquid electrolyte and FIGS. 5A and 5B illustrate characterization of the transference number of a solid-state electrolyte. A high transference number (T+) enables fast lithium ion diffusion through the electrolyte. The transference number of 0.62 at 30 degrees Celsius seen in this solid-state electrolyte is greater than that seen in literature—typically liquid electrolytes have a transference number around 0.37. Table 3 provides the comparative data as well as transference data for higher temperature testing of the solid-state electrolyte.

TABLE 3
Transference of liquid electrolyte and solid-state electrolyte

| Electrolyte | Temperature (° C.) | Transference |
|---|---|---|
| 1M LiPF₆, EC:EMC (3:7 vol) | 30 | 0.37 |
| Solid-State Electrolyte | 30 | 0.62 |
| Solid-State Electrolyte | 45 | 0.77 |

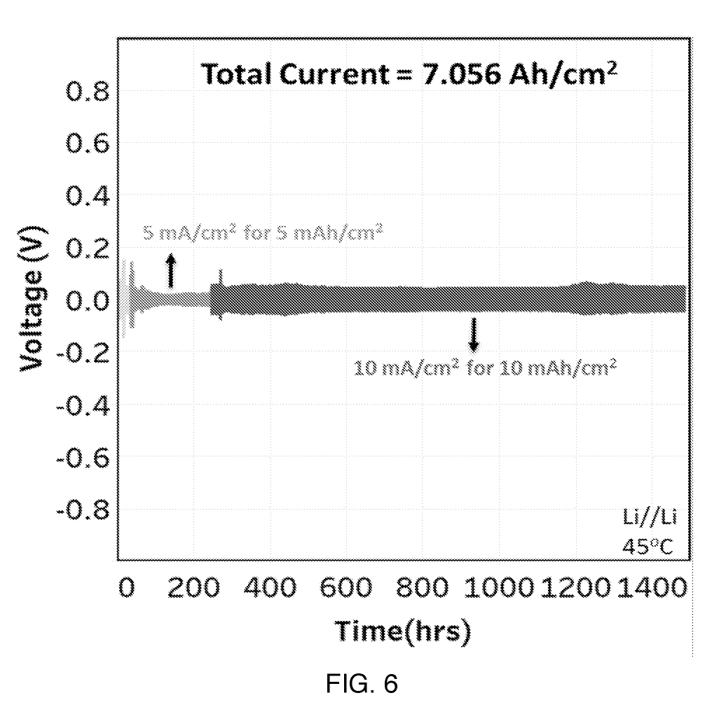

FIG. 6 illustrates stable plating and stripping of lithium as a function of time in cells containing solid-state electrolyte formulations according to certain embodiments of the invention. Symmetric lithium cells show relatively stable plating and stripping at 45 degrees Celsius using a maximum current density of 10 mA/cm² for 10 mAh/cm². The total current density passed through the electrolyte layer totals 7.056 Ah/cm². Again, films fabricated according to the examples disclosed herein are thermally stable over an extended period of time, which is a novel and unexpected result.

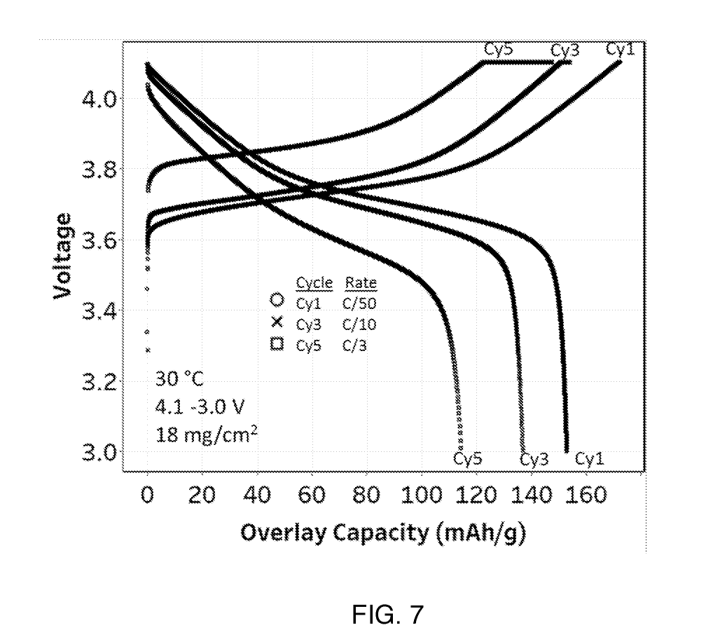

FIG. 7 illustrates electrochemical characterization of battery cells at 30 degrees Celsius including solid-state electrolyte formulations according to certain embodiments of the invention. An embodiment of the solid-state electrolyte demonstrates utility in all solid-state cells with NMC cathode and Li metal anode (no separator needed in the cell) by reaching near theoretical capacity at slow rate (C/50) and adequately moves charge and maintains good interfacial contact higher rates (C/10 and C/3). In FIG. 7, the cathode active material is present at 18 mg/cm².

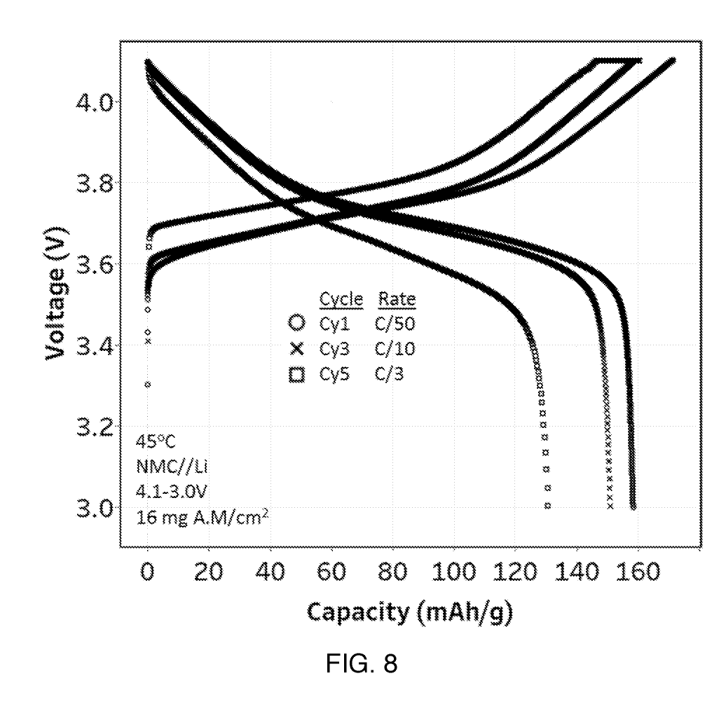

FIG. 8 illustrates electrochemical characterization of battery cells at 45 degrees Celsius including solid-state electrolyte formulations according to certain embodiments of the invention. An embodiment of the solid-state electrolyte demonstrates utility in all solid-state cells with NMC cathode and Li metal anode (no separator needed in the cell) by reaching near theoretical capacity at slow rate (C/50) and adequately moves charge and maintains good interfacial contact at higher rate (C/10 and C/3). In FIG. 8, the cathode active material is present at 16 mg/cm². Thus, a lithium ion cell using polymer electrolyte films fabricated according to the examples disclosed herein demonstrate thermal stability on cycling.

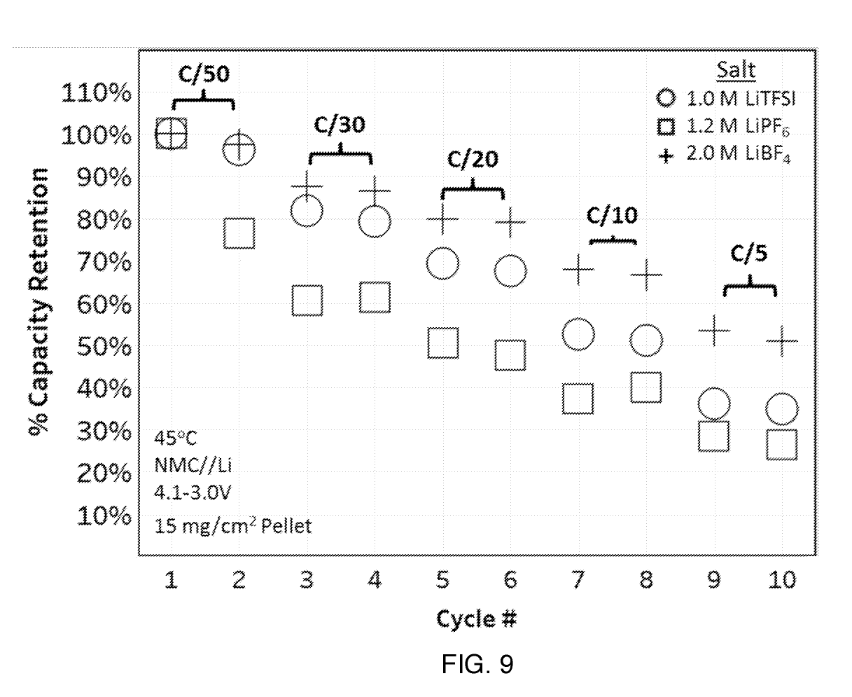

FIG. 9 illustrates capacity retention as a function of cycle number for battery cells including solid-state electrolyte formulations according to certain embodiments of the invention. These solid-state cells demonstrate the effect on cell performance of changing the salt moiety in the electrolyte formulation. Performance improvements can be made through formulation adjustment. In these particular embodiments, 2.0 M LiBF₄ demonstrated the best overall performance. In FIG. 9, the cathode active material is present at 15 mg/cm².

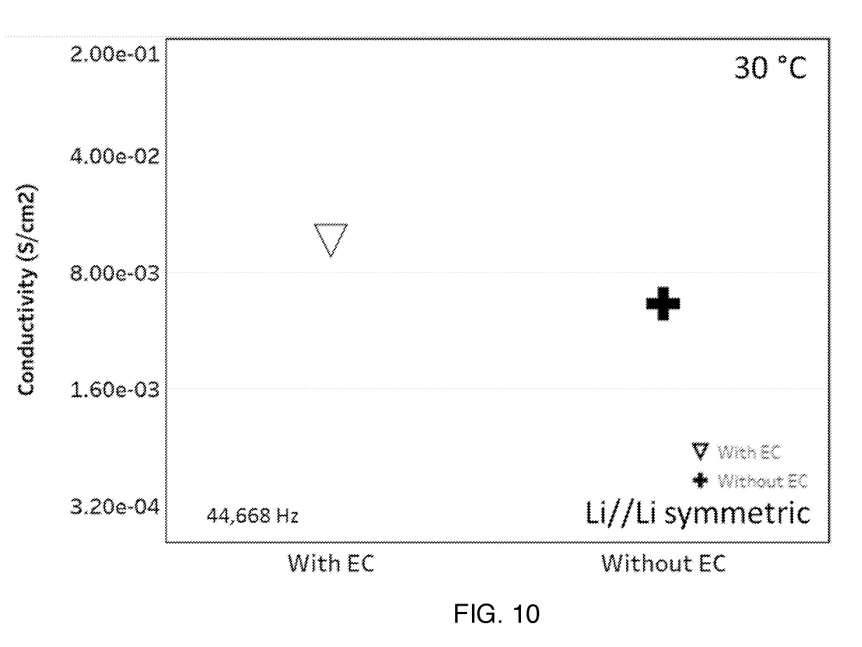

FIG. 10 illustrates the results of electrochemical impedance spectroscopy measurement of the plasticizer dependence of solid-state electrolyte formulations according to certain embodiments of the invention. These measurements illustrate the role of the plasticizer in the stability of the solid-state electrolyte. That is, the conductivity at room temperature is improved through the use of a plasticizer.

FIG. 11 illustrates the results of electrochemical impedance spectroscopy measurement of the plasticizer, temperature, and time dependence of solid-state electrolyte formulations according to certain embodiments of the invention. These measurements show symmetric lithium cells with solid-state electrolyte at 45 degrees Celsius (triangles) and 65 degrees Celsius (circles) over time with ethylene carbonate (solid) and without EC (empty). The conductivity after storage at elevated temperature remains constant (solid circles and solid triangles in FIG. 11) while in a solid-state electrolyte without ethylene carbonate, the conductivity starts to decrease after 50 hours at 45 degrees Celsius or 65 degrees Celsius.

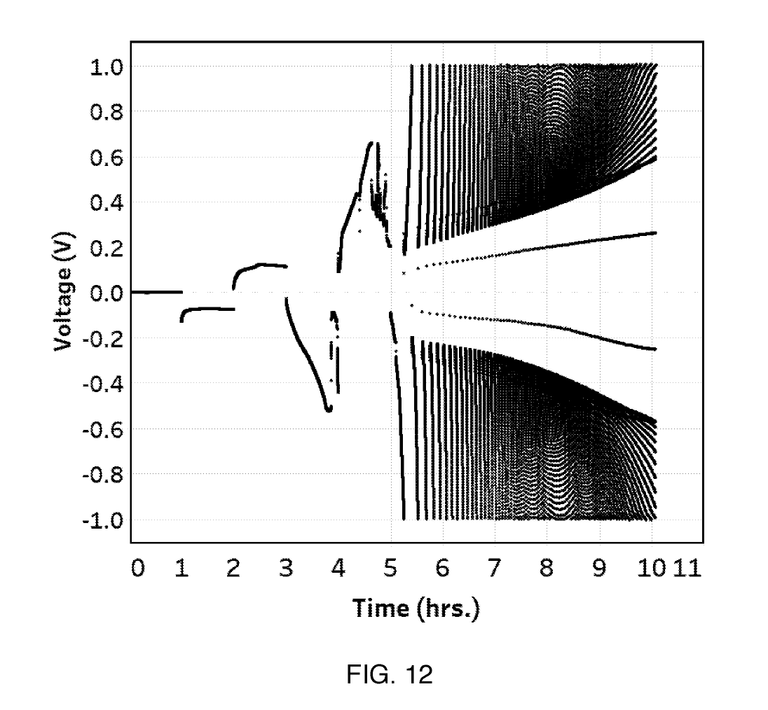

FIG. 12 illustrates unstable plating and stripping of lithium in cells containing certain solid-state electrolyte formulations. Symmetric lithium cells with solid-state electrolyte without ethylene carbonate show unstable plating and stripping at 45 degrees Celsius using a current density of 1.0 mA/cm² for 1.0 mAh/cm² after 5 hours. This confirms that the embodiments of the solid-state electrolyte with ethylene carbonate as shown in FIG. 6 compare favorably. Those symmetric lithium cells with solid-state electrolyte containing ethylene carbonate show relatively stable plating and stripping at 45 degrees Celsius using current densities of up to 10 mA/cm² for a total of 1500 hours without any indication of a cell short. However, the symmetric lithium cells with a solid-state electrolyte having no ethylene carbonate shows unstable plating and stripping after 5 hours, even with a much lower current of 1 mA/cm². In this comparatively short time, the symmetric cell reaches its voltage limit (which means the cell has completely shorted), and the short is likely caused by a lithium dendrite due to the poor mechanical properties of the solid-state electrolyte film that has no ethylene carbonate.

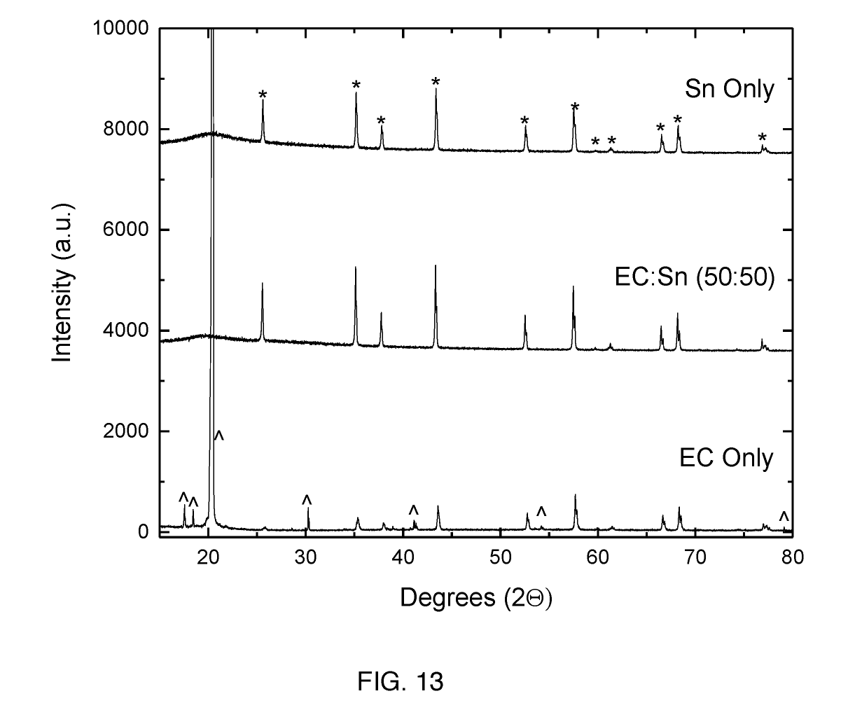

FIG. 13 illustrates x-ray diffraction characterization of solid-state electrolyte formulations according to certain embodiments of the invention. The measurement shows that both the succinonitrile only (labeled “SN Only”) and succinonitrile with EC (labeled “EC:SN (50:50)”) contain crystallinity from the Al₂O₃ filler. Alternatively, the EC only case shows crystallinity from both the Al₂O₃ filler and the organic portion of the composite solid-state electrolyte. In FIG. 13, (̂) denotes the crystalline organic portion of the solid-state electrolyte while (*) denotes the crystalline nature of the Al₂O₃.

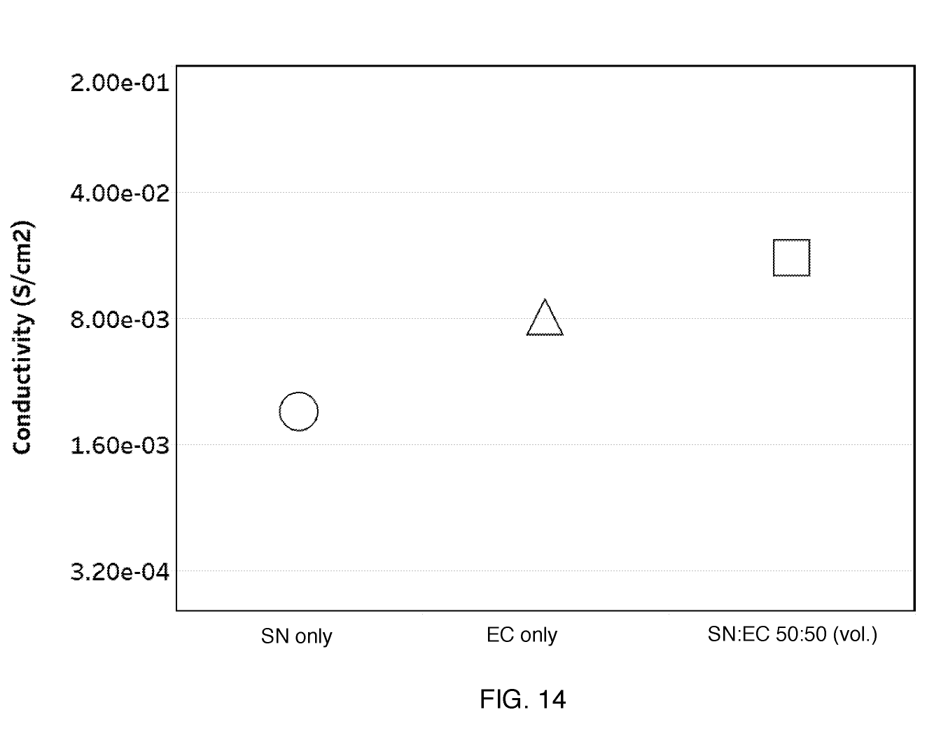

FIG. 14 illustrates the results of electrochemical impedance spectroscopy measurement of the plasticizer dependence of solid-state electrolyte formulations according to certain embodiments of the invention. These measurements illustrate the role of the plasticizer in the conductivity of the solid-state electrolyte. The electrolyte without succinonitrile (EC only), which has crystallinity besides of Al₂O₃ filler, also shows conductivity.

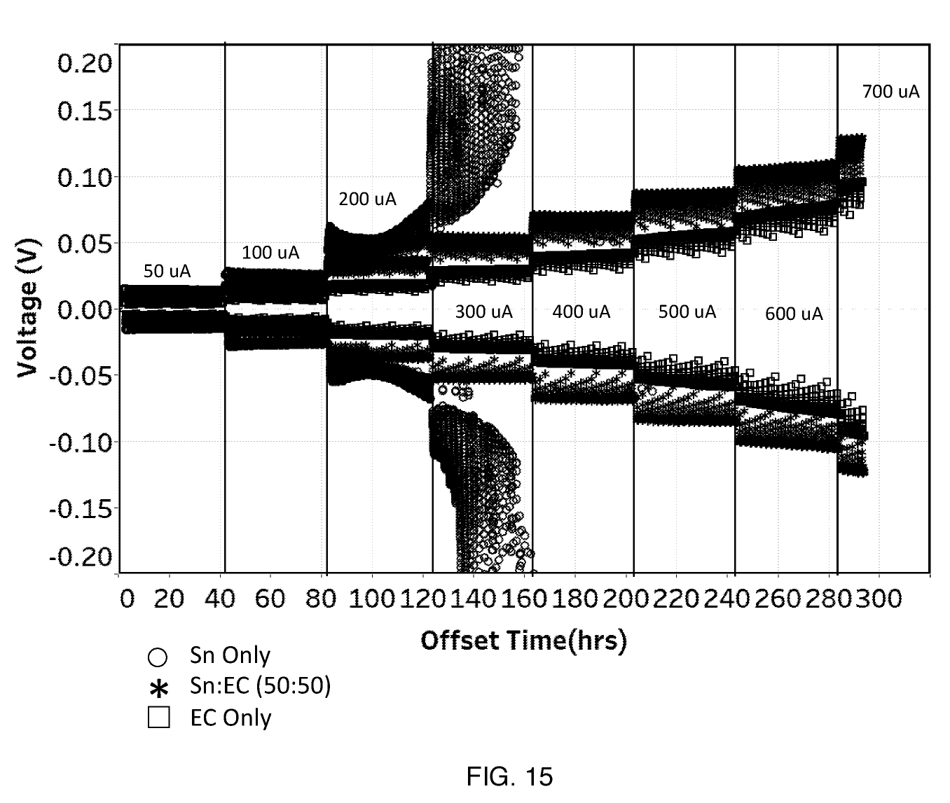

FIG. 15 illustrates unstable plating and stripping of lithium in cells containing certain solid-state electrolyte formulations including a plasticizer and an ion-conducting material. The current was stepwise increased from 50 uA up to 700 uA (vertical lines on the graph mark the time of the stepwise increases). Symmetric lithium cells with solid-state electrolyte without ethylene carbonate (succinonitrile only), in which the film is amorphous, show unstable plating and stripping at current about 300 uA. On the other hand, the cells with solid-state electrolyte with EC:SN=50:50, in which the film has crystallinity, show relatively stable voltage even at 700 uA. This confirms that an amorphous property is not necessary for this solid-state electrolyte.

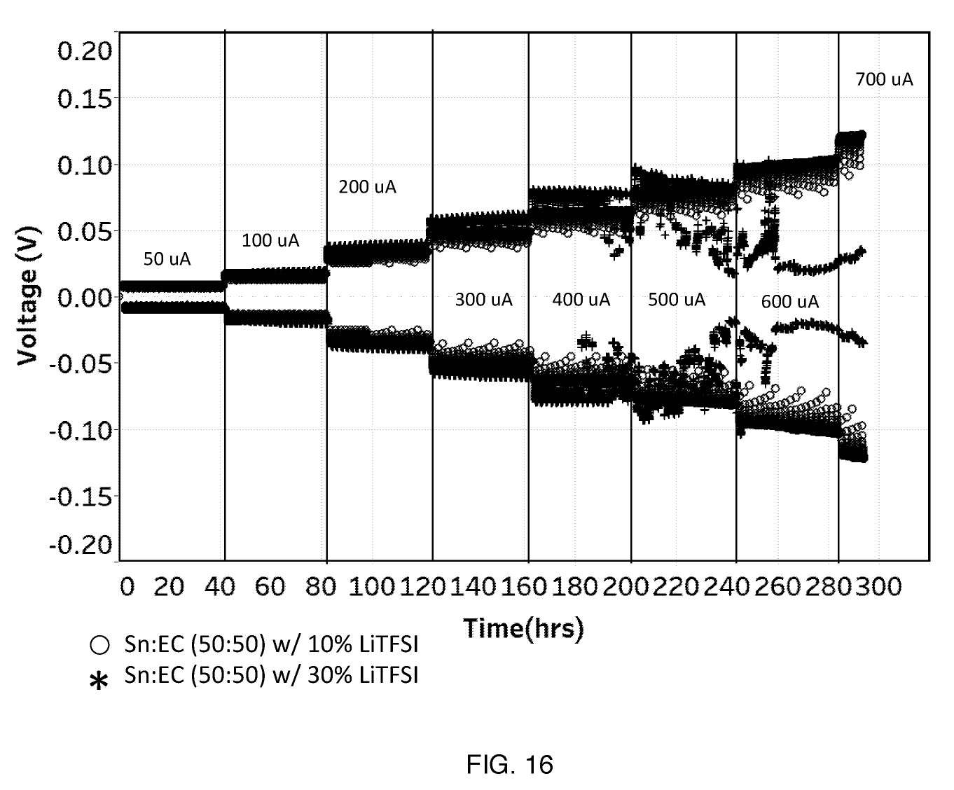

FIG. 16 illustrates unstable plating and stripping of lithium in cells containing certain solid-state electrolyte formulations including a plasticizer and an ion-conducting material with different amounts of salt. The current was stepwise increased from 50 uA up to 700 uA (vertical lines on the graph mark the time of the stepwise increases). Symmetric lithium cells with solid-state electrolyte with EC:SN=50:50 and 30 weight percent lithium salt show unstable plating and stripping at current about 400 uA, on the other hand, the cells with solid-state electrolyte with EC:SN=50:50 and 10 weight percent lithium salt show relatively stable voltage even at 700 uA. This confirms that the salt amount has a significant effect for the performance of this solid-state electrolyte.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit, and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A formulation, comprising:
a multifunctional acrylate monomer;
a polymerization initiator;
a plasticizer;
an inorganic ion-conducting material; and
a lithium salt.

2. The formulation of claim 1, wherein the multifunctional acrylate monomer is represented by formula (b): 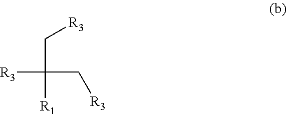
where R₁ is selected from the group consisting of alkyl groups and alkoxy groups and R₃ comprises both alkoxy groups and acrylate groups.

3. The formulation of claim 2, wherein R₃ is represented by formula formula (c): 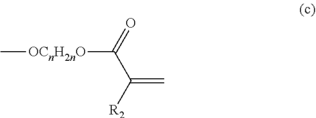
where R₂ is an alkyl group.

4. The formulation of claim 2, wherein R₃ is represented by formula (d) 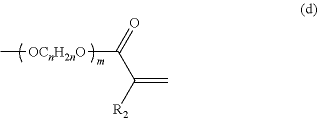
where R₂ is an alkyl group, n is an integer less than or equal to 6, and 5≤m≤2000.

5. The formulation of claim 1, wherein the multifunctional acrylate monomer is represented by formula (e):

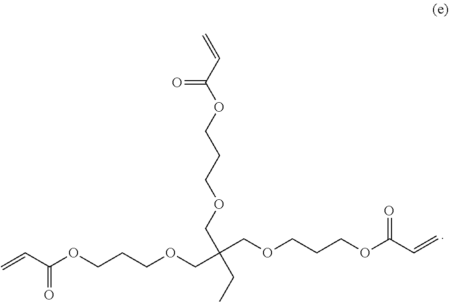 [SMILES: C=CC(=O)OCCCOCC(CC)(COCCCOC(=O)C=C)COCCCOC(=O)C=C]

6. The formulation of claim 1, wherein the polymerization initiator comprises a free-radical initiator activated by photo initiation, thermal initiation, or electron beam initiation.

7. The formulation of claim 6, wherein the polymerization initiator comprises 2-hydroxy-2-methylpropiophenone.

8. The formulation of claim 1, wherein the plasticizer comprises an organic molecule with high dielectric constant.

9. The formulation of claim 1, wherein the plasticizer comprises ethylene carbonate.

10. The formulation of claim 1, wherein the plasticizer comprises a nitrile-based organic crystal.

11. The formulation of claim 1, wherein the plasticizer comprises succinonitrile.

12. The formulation of claim 1, wherein the inorganic ion-conducting material is selected from the group consisting of Al₂O₃, SiO₂, TiO₂, and ZrO₂.

13. The formulation of claim 1, wherein the inorganic ion-conducting material comprises Al₂O₃.

14. The formulation of claim 1, wherein the inorganic ion-conducting material comprises a garnet-type ion conducting material.

15. The formulation of claim 1, wherein the inorganic ion-conducting material comprises a NASICON-type ion conducting material.

16. The formulation of claim 1, wherein the lithium salt comprises lithium bis(trifluoromethanesulfonyl)imide.

17. A solid polymer electrolyte, comprising:
a crosslinked acrylate homopolymer;
an organic plasticizer;
an inorganic ion-conducting material; and
a lithium salt.

18. The solid polymer electrolyte of claim 17, wherein the organic plasticizer comprises an organic molecule with high dielectric constant.

19. The solid polymer electrolyte of claim 17, wherein the organic plasticizer comprises ethylene carbonate.

20. The solid polymer electrolyte of claim 17, wherein the organic plasticizer comprises a nitrile-based organic crystal.

21. The solid polymer electrolyte of claim 17, wherein the organic plasticizer comprises succinonitrile.

22. The solid polymer electrolyte of claim 17, wherein the inorganic ion-conducting material is selected from the group consisting of Al₂O₃, SiO₂, TiO₂, and ZrO₂.

23. The solid polymer electrolyte of claim 17, wherein the inorganic ion-conducting material comprises Al₂O₃.

24. The solid polymer electrolyte of claim 17, wherein the inorganic ion-conducting material comprises a garnet-type ion conducting material.

25. The solid polymer electrolyte of claim 17, wherein the inorganic ion-conducting material comprises a NASICON-type ion conducting material.

26. The solid polymer electrolyte of claim 17, wherein the lithium salt comprises lithium bis(trifluoromethanesulfonyl)imide.
